(19) United States
(12) Patent Application Publication
(10) Pub. No.: US 2011/0291363 A1
(43) Pub. Date: Dec. 1, 2011

(54) PILLOW BLOCK SEAL

(76) Inventor: Keith Allen Bartley, Odessa, TX (US)

(21) Appl. No.: 12/788,798

(22) Filed: May 27, 2010

(51) Int. Cl. F16J 15/447; F16C 33/72

(52) U.S. Cl. 277/412

(57) ABSTRACT

A seal for a pillow block that supports a rotating shaft includes an annular body having an inner surface opposite an outer surface. Disposed in the inner surface is a retaining channel that retains two double-wound laminar gripping rings that are separated by a double-wound laminar engagement ring. The gripping rings are dimensioned to frictionally engage and are carried by the shaft as it rotates. The engagement ring remains fixed within the retaining channel relative to the rotating gripping rings, resultantly forming a labyrinth seal to prevent the intrusion of particles and debris from entering the pillow block to prevent the contamination of lubricants contained therein.

### TECHNICAL FIELD

Generally, the present invention relates to a seal for protecting bearings. More particularly, the present invention relates to a seal for a pillow block that utilizes laminar rings to form a labyrinth seal about a rotating shaft carried thereby.

### BACKGROUND ART

Pillow blocks are typically used to house and retain a self-aligning bearing that carries a rotating shaft. In addition, the pillow block also serves to maintain lubricants, such as grease and oil, so that they are in continuous contact with the moving components of the bearing. In order to prevent particles, such as dirt and other debris, from damaging the bearing, seals are provided at each interface where the shaft extends through the pillow block. These seals come in direct contact with the rotating shaft, resulting in friction that causes them to wear. The worn seals gradually allow the intrusion of particles and other debris into the pillow block, causing the lubrication to become contaminated. This contamination ultimately leads to the premature wear and failure of the bearing, thus necessitating its replacement, which is undesirable. Thus, seals that are currently in use do not provide an adequate operating life, which leads to the premature failure of the pillow block bearing.

Therefore, there is a need in the art for a pillow block seal that utilizes double-wound laminar rings to form a labyrinth seal to prevent the intrusion of particles and other debris from entering the pillow block at each interface where a rotating shaft extends through the pillow block. In addition, there is also a need for a pillow block seal that utilizes a rotating collar that is attached to the rotating shaft and a fixed annular body that is retained by the pillow block to prevent the intrusion of particles and other debris from entering the pillow block when the shaft is rotating at high speeds.

### SUMMARY OF INVENTION

In light of the foregoing, it is a first aspect of the present invention to provide a seal for a pillow block carrying a rotating shaft comprising an annular body having an inner surface that opposes an outer surface; a retaining channel defined by said inner surface; and at least a first ring and a second ring disposed within said retaining channel, such that said first ring is engaged with the rotating shaft and carried therewith, and said second ring is engaged with said annular body of the seal.

It is another aspect of the present invention to provide a pillow block for a rotating shaft comprising a pillow block having at least one interface aperture to receive the rotating shaft therethrough; and a seal disposed within said at least one aperture, said seal comprising an annular body having an inner surface that opposes an outer surface; a retaining channel defined by said inner surface; and at least a first ring and a second ring disposed within said retaining channel, such that said first ring is engaged with the rotating shaft and carried therewith, and said second ring is engaged with said annular body of said seal.

Yet another aspect of the present invention is to provide a seal for a pillow block that carries a rotating shaft comprising a rotating collar having an opposed inner and outer surface, and adapted to be attached and carried with the rotating shaft, said rotating collar having a retaining channel defined by said outer surface; a fixed annular body having an opposed inner and outer surface, said annular body adapted to be mounted to the pillow block, said fixed annular body having an engagement flange that forms an engagement recess to receive at least a portion of said rotating collar, such that said engagement flange extends over said retaining channel; and at least a first ring and a second ring disposed within said retaining channel, such that said first ring is engaged with said engagement flange and said second ring is engaged with said rotating collar, so as to be rotatably carried therewith.

A further aspect of the present invention is to provide a pillow block for a rotating shaft comprising a pillow block having at least one interface aperture to receive a rotating shaft therethrough; a rotating collar having an opposed inner and outer surface, and adapted to be attached and carried with the rotating shaft, said rotating collar having a retaining channel defined by said outer surface; a fixed annular body having an opposed inner and outer surface, said fixed annular body disposed in said at least one interface aperture of said pillow block, said fixed annular body having an engagement flange that forms an engagement recess to receive at least a portion of said rotating collar, such that said engagement flange extends over said retaining channel; and at least a first ring and a second ring disposed within said retaining channel, such that said first ring is engaged with said engagement flange and said second ring is engaged with said rotating collar, so as to be rotatably carried therewith.

### BRIEF DESCRIPTION OF THE DRAWINGS

One or more objects and advantages of the present invention will become apparent from the subsequent detailed description of the preferred embodiment and the appended claims taken in conjunction with the accompanying drawings where:

FIG. 1 is a cross-sectional view of a pillow block showing seals providing a labyrinth seal in accordance with the concepts of the present invention;

FIG. 2 is a cross-sectional view of the pillow block seal carrying double-wound laminar gripping and engagement rings in accordance with the concepts of the present invention;

FIG. 3 is a partial elevational view of the components of the pillow block labyrinth seal in accordance with the concepts of the present invention;

FIG. 4 is a partial perspective view of the pillow block seal in accordance with the concepts of the present invention;

FIG. 5 is an exploded view of the pillow block, seals, and associated components in accordance with the concepts of the present invention;

FIG. 5A is a perspective view of the double-wound laminar gripping and engagement rings in accordance with the concepts of the present invention;

FIG. 6 is a cross-sectional view of an alternative embodiment of the pillow block showing a seal having a fixed annular body and rotating collar that are interfaced by a labyrinth seal in accordance with the concepts of the present invention;

FIG. 7 is a partial elevational view of the components of the pillow block labyrinth seal in accordance with the concepts of the present invention;

FIG. 8 is an exploded view of the pillow block, seals, and associated components in accordance with the concepts of the present invention; and

FIG. 8A is a perspective view of the double-wound laminar rings utilized by the seal in accordance with the concepts of the present invention;

### DETAILED DESCRIPTION OF THE INVENTION

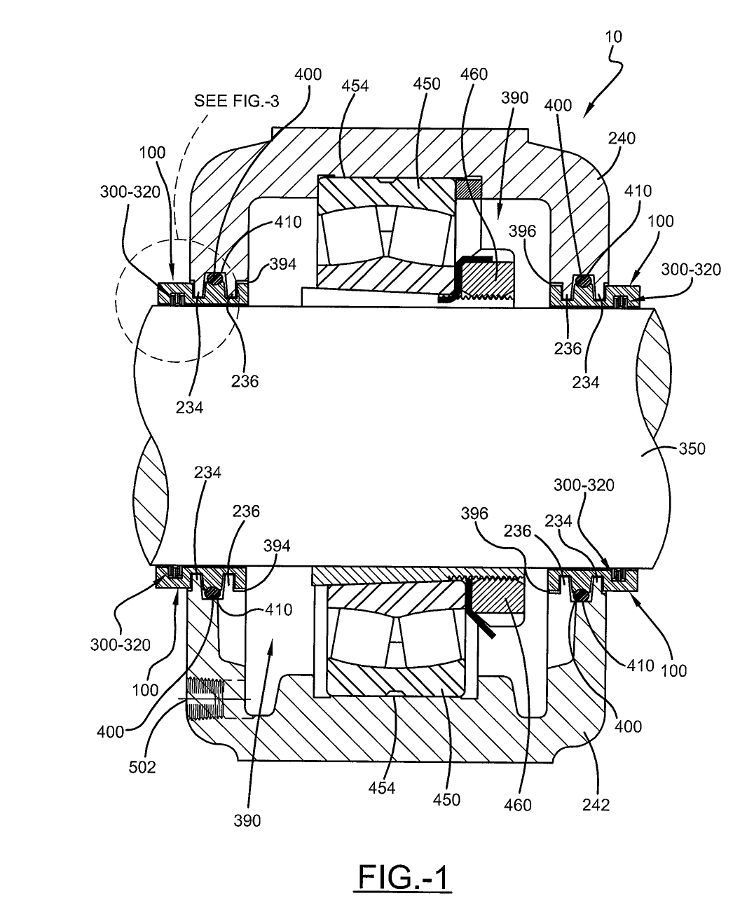

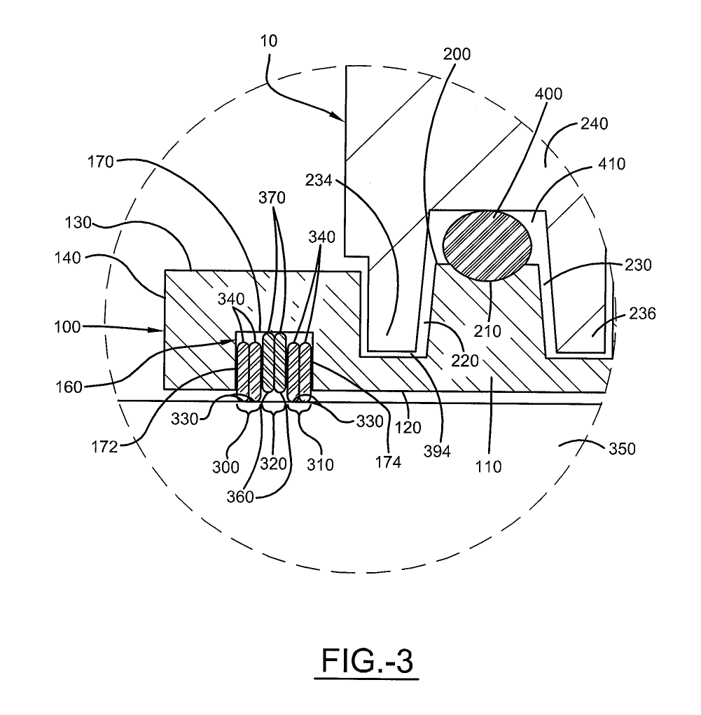

A seal for a pillow block 10 is generally referred to by the numeral 100, as shown in FIGS. 1-5A of the drawings. Shown clearly in FIG. 3, the seal 100 comprises an annular body 110 having opposed inner and outer surfaces 120 and 130 that are bounded by opposed front and rear edges 140 and 150. Circumferentially disposed about, or otherwise defined by, the inner surface 120 proximate to the front edge 140 of the seal body 110 is a retaining channel 160 that is defined by an annular channel wall 170 that is bounded by opposed lateral retaining walls 172,174 that extend therefrom at a substantially right angle. Extending from the outer surface 130 of the body 110 is an annular ring support 200, which includes a curved retention groove 210 thereon. The ring support 200 is positioned between a pair of mounting channels 220 and 230 that are spaced and dimensioned to receive corresponding engagement protrusions 234 and 236 provided by top and bottom case sections 240, 242 that comprise the pillow block 10 to be discussed.

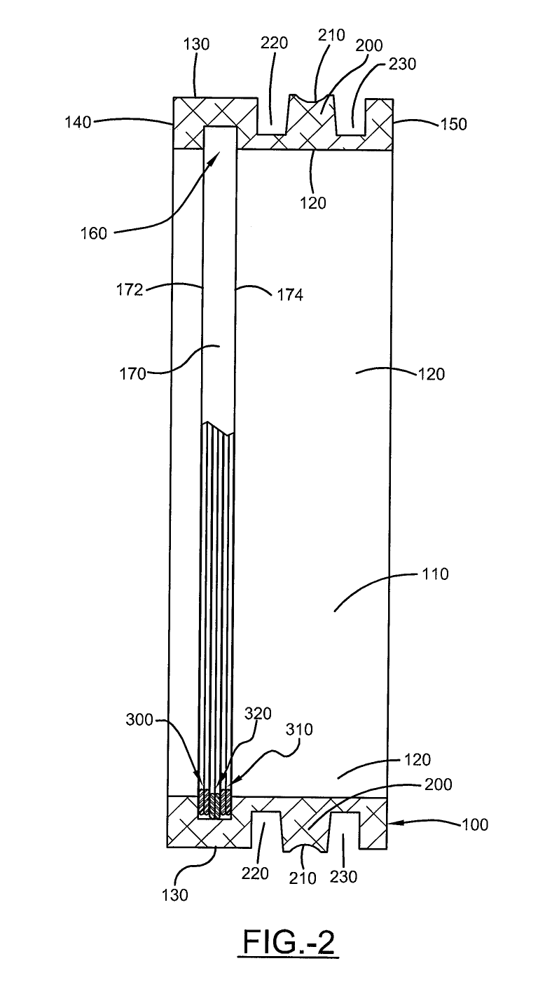

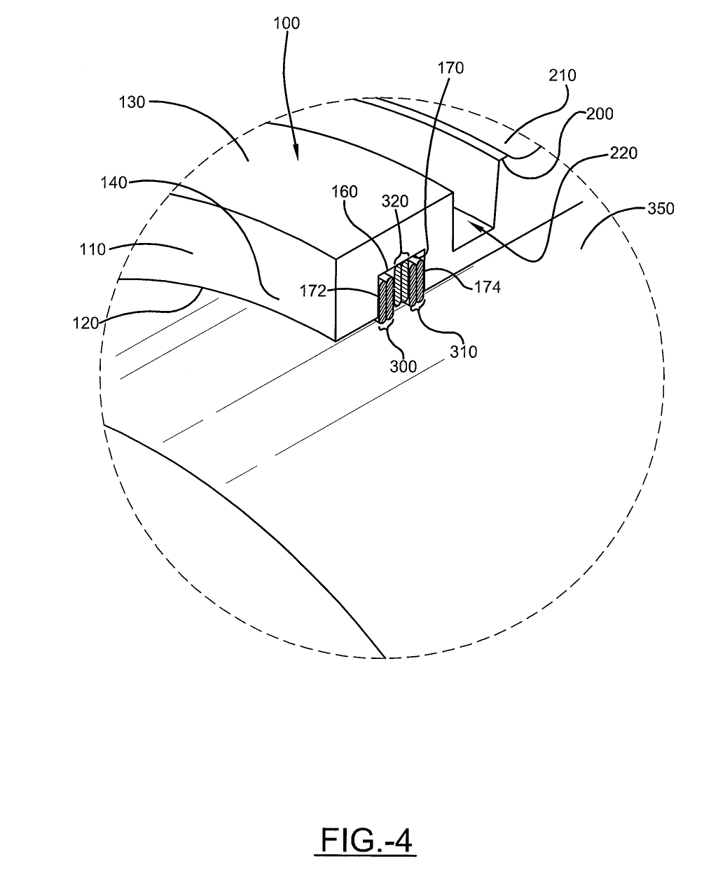

Disposed within the retaining channel 160 are two annular gripping rings 300 and 310 that are spaced apart by an annular engagement ring 320 disposed therebetween, as shown clearly in FIGS. 2 and 4. The gripping and engagement rings 300-320 comprise double-wound laminar rings having a substantially rectangular cross-section and may be formed from any suitable material, such as stainless steel. However, it should be appreciated that the rings 300-320 may comprise any suitable cross-sectional shape. Moreover, the gripping and engagement rings 300-320 may comprise double-wound laminar rings provided by Smalley Steel Ring Company. Specifically, the gripping rings 300,310 include an inner edge 330 defining its inner diameter and an outer edge 340 defining its outer diameter. As such, the gripping rings 300,310 are dimensioned such that their inner edge 330 is sized to be press fit over the outer diameter of a shaft 350, allowing the gripping rings 300,310 to be carried with the rotating movement of the shaft 350. The engagement ring 320 includes an inner edge 360 defining its inner diameter and an outer edge 370 defining its outer diameter. As such, the engagement ring 320 is dimensioned such that its outer edge 370 is sized to frictionally engage the channel wall 170 of the retaining channel 160, so as to be held in a fixed position relative to the gripping rings 300,310. That is, the gripping rings 300,310 are friction or interference fit with the shaft 350, while the engagement ring 320 is friction or interference fit with the retaining channel 160 of the seal body 110. Thus, as the shaft 350 rotates, the gripping rings 300,310 rotate relative to the stationary or fixed engagement rings 320, so as to form a labyrinth seal about the shaft 350. The labyrinth seal formed by the rings 300-320 serves as a barrier to particles and debris that attempt to penetrate at the interface between the shaft 350 and the annular seal body 110.

The pillow block 10 comprises top and bottom case sections 240,242, which when coupled form an internal mounting cavity 390, and a pair of axially-aligned interface apertures 394,396 that each retain a seal 100 therein. The annular interface apertures 394 and 396, formed by the coupling of the top and bottom case sections 240,242 together, include the annular engagement protrusions 234 and 236, which are received by the mounting channels 220,230 of the seal 100 that is disposed therein. Carried within the curved channel 210 is a ring seal 400, such as a rubber o-ring seal, which is compressively engaged with an annular receiving channel 410 that is disposed between the engagement protrusions 234 and 236 of the pillow block 100. Moreover, when each seal 100 is mounted within each of the interface apertures 394,396, the rear edge 150 of each seal 100 is oriented so that it is proximate to the internal mounting cavity 390, and the front edge 140 is distal to the internal mounting cavity 390 of the pillow block 10.

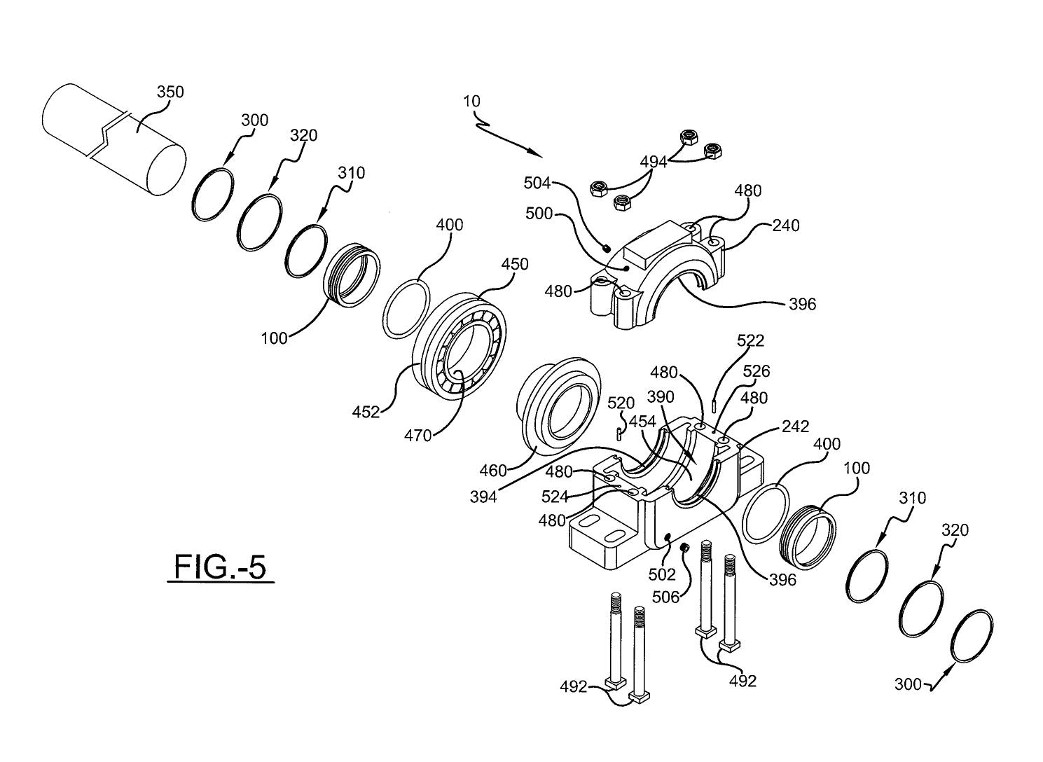

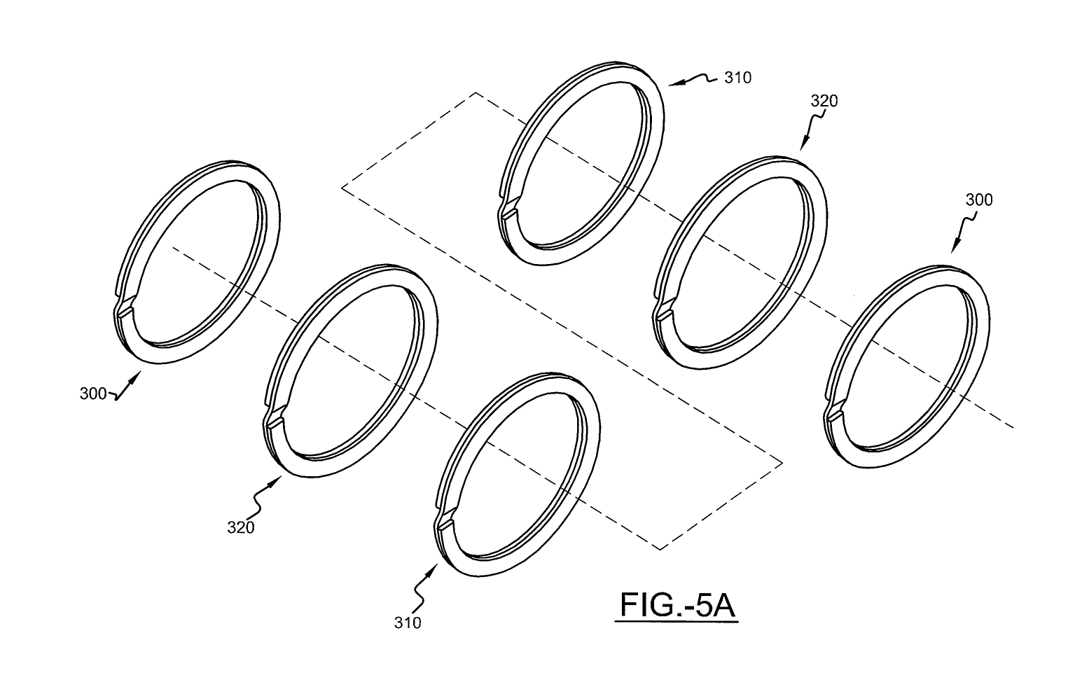

With reference to FIGS. 1 and 5, the internal mounting cavity 390 of the pillow block 10 is configured to retain a bearing 450, such that its outer race 452 is seated against an annular mounting surface 454 provided by the pillow block 10, while an adapter ring 460 is seated within an inner race 470 of the bearing 450. Specifically, the adapter ring 460 serves to attach the bearing 450 to the shaft 350, such that as the shaft 350 rotates, it rotatably drives the adapter 460 and the inner race 470 of the bearing 450. In addition, a plurality of bores 480 are disposed through the top and bottom case sections 240,242 of the pillow block 10, which are dimensioned to receive suitable fasteners, such as bolts 492, therethrough, which are threadably retained by nuts 494.

The pillow block 10 also includes grease ports 500 and 502 that are disposed in the respective top and bottom case sections 240,242 to facilitate the application of grease and/or other lubricants into the internal mounting cavity 390 of the pillow block 10 to lubricate the bearing 450. Caps 504 and 506 are provided to cover or otherwise be threadably received within respective grease ports 500 and 502 during operation of the pillow block 10 to prevent the intrusion of particles or other debris into the internal mounting cavity 390.

The top and bottom case sections 240,242 of the pillow block 10 may be aligned by pins 520 and 522, which are received in complementary bores 524 and 526 that are disposed in the top and bottom case sections 240,242 on either side of the pillow block 10. The alignment pins 520,522 ensure that the top and bottom case sections 240,242 are precisely aligned and facilitate the assembly of the pillow block 10 while providing additional rigidity thereto.

Thus, to place the pillow block 10 into operation using the seals 100, the shaft 350 is received through the adapter ring 460, which is rotatably carried by the inner race 470 of the bearing 450. In addition, the seals 100 are placed over the shaft 350, such that the gripping rings 300,310 frictionally engage the shaft 350. The seals 100, as well as the bearing 450 and adapter ring 460, are then compressively retained within the interface apertures 394,396 of the pillow block 10 by securing the top and bottom case sections together using nuts 494 and bolts 492. As such, the mounting protrusions 234,236 of the pillow block case sections 240,242 are received within the mounting channels 220,230 of the each of the seals 100, so as to compress the ring seal 400. It should be appreciated that the seals 100 are oriented within the interface apertures 390,392, such that the front edge 140 is distal and the rear edge 150 is proximate to the internal mounting cavity 390 of the pillow block 10. It should be appreciated that the seal 100 may be used with a pillow block 10 that has any number of interface apertures 394,396.

As such, the laminar rings 300-320 provided by the seals 100 forms a labyrinth seal between the interface of the shaft 350 and the inner surface 120 of the seal body 110. Thus, as the shaft 350 rotates, the gripping rings 300,310 rotate relative to the fixed engagement ring 320, and the labyrinth seal formed thereby prevents the intrusion of particles and debris from entering the internal mounting cavity 390 of the pillow block 10. This operation prevents contamination of the materials carried within the cavity 390 that lubricate and cool the bearing 450, thus allowing the bearing 450 to have an extended operating life. Moreover, because the gripping rings 300,310 are rotatably carried by the shaft 350, the labyrinth seal formed by the seal 100 will not wear the surface of the shaft 350, thus allowing the seal 100 to have a long operating life.

In another aspect of the present invention, the seal 600 may be configured such that any number of gripping rings 300,310 and engagement rings 320 may be used, as long as at least one gripping ring and one engagement ring are used. For example, the seal 100 may be configured with only one gripping ring and one engagement ring. Moreover, while the gripping and engagement rings 300-320 comprise double-wound laminar rings, single or multiple-wound laminar rings may also be utilized. Additionally, the gripping and engagement rings 300-320 may comprise double-wound laminar rings manufactured by Smalley Steel Ring Company.

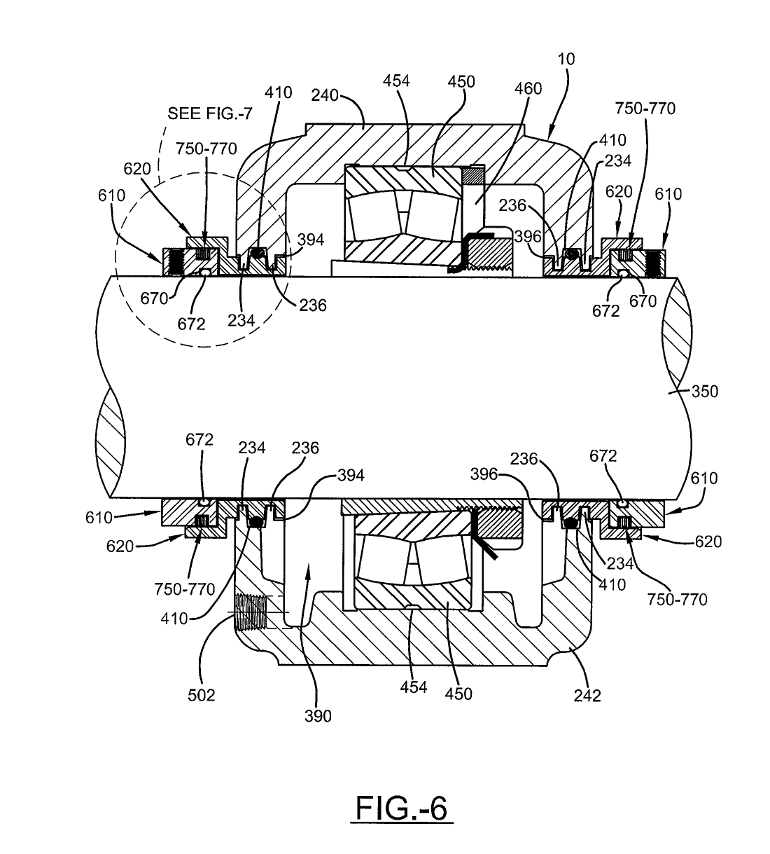

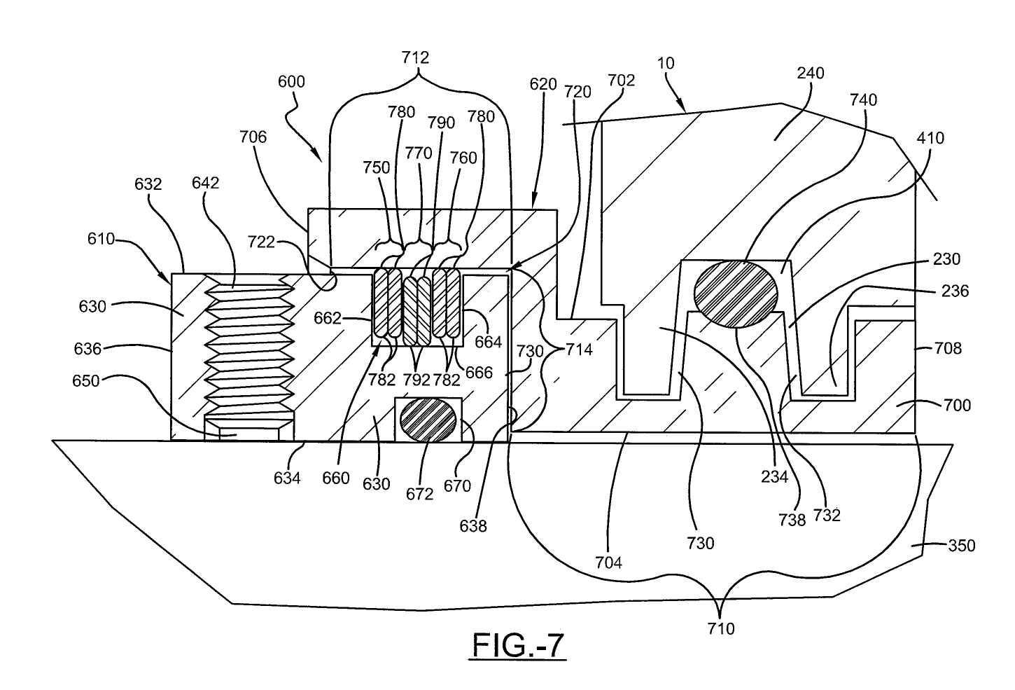

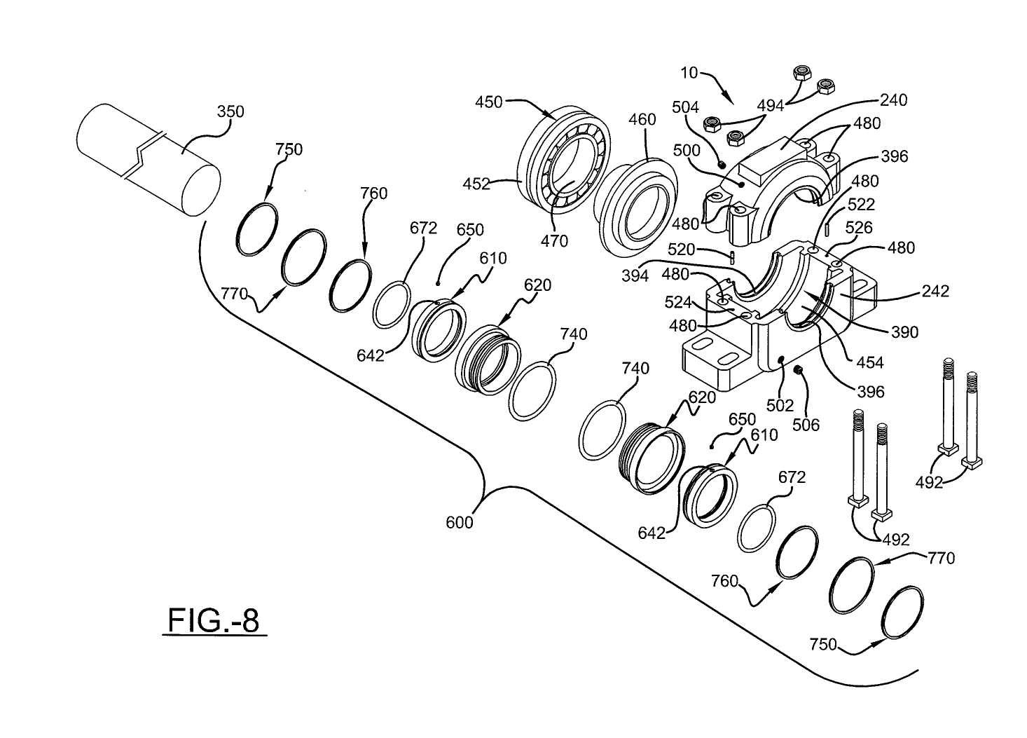

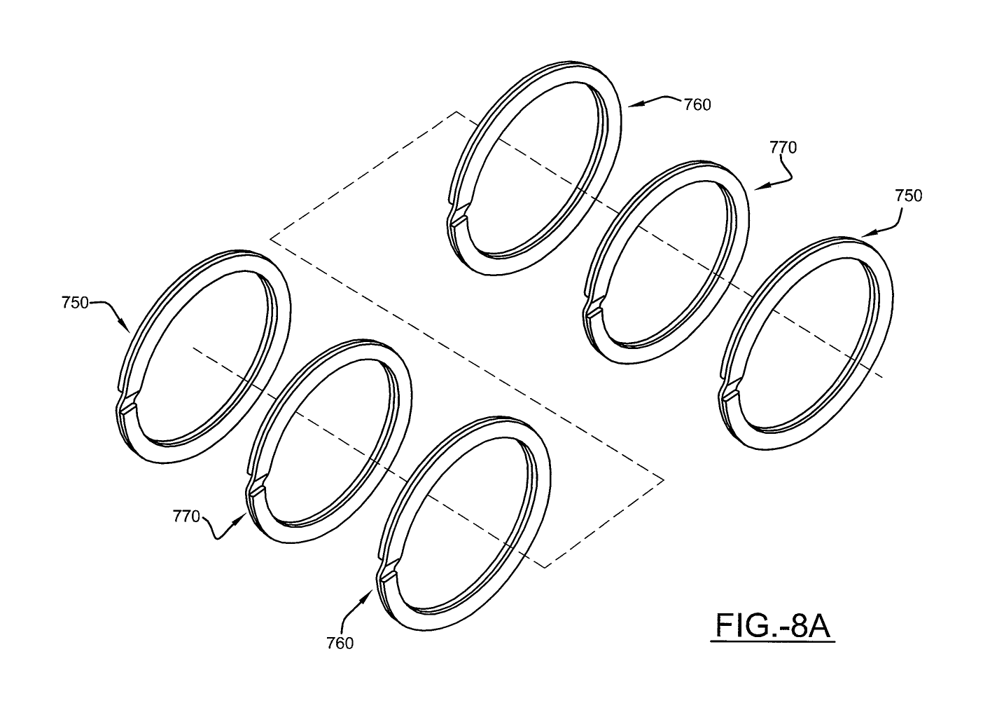

In another embodiment, a pillow block seal referred to by the numeral 600 for use with the pillow block 10 comprises a rotating collar 610 and a fixed annular body 620, as shown in FIGS. 6-8A of the drawings. The rotating collar 610 comprises an annular body 630 that includes opposed outer and inner surfaces 632 and 634 that are laterally bounded by opposed front and rear edges 636,638. Extending at a substantially perpendicular angle between the outer and inner surfaces 632,634 of the body 630 is a threaded bore 642 that is dimensioned to threadably receive a setscrew 650 therein. As such, when the shaft 350 is received within the rotating collar 610, the setscrew 650 is secured against the shaft 350 so that the rotating collar 610 is carried with the rotation of the shaft 350. However, it should be appreciated that the rotating collar 610 may be retained to the shaft 350 using any suitable means of fixation, such as adhesive or compression or interference fit for example. The rotating collar 610 also includes a retaining channel 660 disposed circumferentially about, or otherwise defined in, the outer surface 632 of the body 630. Specifically, the retaining channel 660 comprises opposed lateral retaining walls 662 and 664 that are joined at a substantially right angle by an annular channel wall 666. In addition, circumferentially disposed about, or defined in, the inner surface 634 of the body 630 is a seal channel 670 that retains a seal ring 672, such as a rubber o-ring, for sealing engagement with the shaft 350.

The fixed annular body 620 comprises an annular body 700 having opposed outer and inner surfaces 702 and 704 that are laterally bounded by a front edge 706 and a rear edge 708. The inner surface 704 of the fixed annular body 620 comprises a guide section 710 that extends from the rear edge 708 and an engagement flange 712 that extends from the front edge 706. The guide section 710 and the engagement flange 712 are joined at a point proximate to the front edge 706 by an offset section 714 that extends therebetween at a substantially perpendicular angle, thereby offsetting the guide section 710 and engagement flange 712. Specifically, the guide section 710 is proximate to the surface of the shaft 350, while the engagement flange 712 is distal to the shaft 350. Together, the offset engagement flange 712 and substantially perpendicular offset section 714 form an engagement recess 720 that is dimensioned to receive the vertical cross-sectional dimension of the rotating collar 610 that is defined by its front and rear edges 636,638. In addition, a retaining protrusion 722 extends at a substantially perpendicular angle from the engagement flange 712, so as to contact the outer surface 632 of the rotating collar 610 at a point between the setscrew bore 642 and the retaining channel 660.

Disposed on the outer surface 702 of the fixed annular body 620 is a pair of spaced mounting channels 730,732 that are separated by a ring support 736. The ring support 730 extends from the outer surface 702 of the fixed annular body 620 and includes a curved retention groove 738 that is configured to retain a seal ring 740, such as a rubber o-ring.

As such, the fixed annular body 620 is configured to be mounted within each of the two interface apertures 394,396 provided by the pillow block 10, such that the mounting protrusions 234,236 are received within the mounting channels 730,732 of the fixed annular body 620, so as to compressively engage the seal ring 740 carried by the ring support 736. It should be appreciated that the seal 600 may be used with pillow blocks 10 that include one or more interface apertures 394,396. Specifically, the fixed annular body 620 is mounted with the interface apertures 394,396 of the pillow block 10, such that the rear edge 708 is proximate and the front edge 706 is distal to the internal mounting cavity 390. The rotating collar 610 is disposed within the engagement recess 720, such that the rear edge 730 of the rotating collar 610 is adjacent to the offset section 714, such that the retaining protrusion 722 engages the outer surface 632 of the rotating collar 610 at a point between the threaded bore 642 and the retaining channel 660.

Disposed within the retaining channel 660 are two gripping rings 750 and 760 that are spaced apart by an annular engagement ring 770 disposed therebetween. The engagement and gripping rings 750-770 comprise double-wound laminar rings, having a substantially rectangular cross-section and may be formed from any suitable material, such as stainless steel. However, it should be appreciated that the rings 750-770 may comprise any suitable cross-sectional shape. Specifically, the gripping rings 750,760 include an outer edge 780 defining its outer diameter and an inner edge 782 defining its inner diameter. As such, the gripping rings 750,760 are dimensioned, such that their outer edge 780 is sized to be press fit or to otherwise frictionally engage the inner surface 704 of the engagement flange 712. In addition, the engagement ring 770 includes an outer edge 790 defining its outer diameter and an inner edge 792 defining its inner diameter. Thus, the engagement rings 770 are dimensioned, such that its inner edge 792 is sized to frictionally engage the engagement wall 666 of the retaining channel 660. That is, the gripping rings 750,760 are interferenced with or otherwise frictionally engaged with the fixed annular body 620, while the engagement ring 770 is interferenced with or otherwise frictionally engaged with the retaining channel 660 of the rotating collar 610.

To place the pillow block 10 into operation, the bearing 450 and adapter ring 460 are disposed within the internal mounting cavity 390 of the pillow block 10, while the fixed annular body 620 of seal 600 is retained in the interface apertures 394 an 396 of the pillow block 10, as previously discussed with regard to seal 100. As such, the seals 600, bearing 450, and adapter ring 460 are compressively retained, securing the upper and lower case sections 240,242 of the pillow block together, as previously discussed. Thus, during operation, the shaft 350 is received through the rotating collar 610, fixed annular body 620, and the interface apertures 394,396 of the pillow block 10. And as the shaft 350 rotates, it carries the rotating collar 610, such that the engagement ring 770 is rotated relative to the fixed gripping rings 750,760. As such, the laminar rings 750-770 form a labyrinth seal between the fixed annular body 620 and the rotating collar 610 to prevent the intrusion of particles and debris into the internal mounting cavity 390 of the pillow block 10 as the shaft 350 rotates. This operation prevents contamination of the materials carried within the cavity 390 that lubricate and cool the bearing 450, thus allowing the bearing 450 to have an extended operating life. Moreover, because the engagement ring 770 is rotatably carried by the shaft 350, the labyrinth seal formed by the seal 600 will not wear the surface of the shaft 350, allowing the seals 600 to have a long operating life.

In another aspect of the present invention, the seal 600 may be configured such that any number of gripping rings 750,760 and engagement rings 770 may be used, as long as at least one gripping ring and one engagement ring are utilized. For example, the seal 600 may be configured with only one gripping ring and one engagement ring. Moreover, while the gripping and engagement rings 750-770 comprise double-wound laminar rings, single or multiple-wound laminar rings may also be utilized.

It will, therefore, be appreciated that one advantage of one or more embodiments of the present invention is that a pillow block seal utilizes double-wound laminar rings to form a labyrinth seal to prevent the intrusion of debris into the pillow block without causing wear to the surface of the rotating shaft carried by the pillow block. Another advantage of the present invention is that a pillow block seal is configured for use with a standard pillow block. Still another advantage of the present invention is that a pillow block seal provides a rotating collar carried by a rotating shaft, which is coupled by a labyrinth seal with a fixed annular body retained by a pillow block to provide suitable sealing properties at high shaft speeds.

Thus, it can be seen that one or more aspects of the invention have been satisfied by the structure and methods provided above. In accordance with the Patent Statutes, only the best mode and certain alternative embodiments have been presented in the application and described in any detail. It should be understood that the spirit and scope of the appended claims should not be limited to the description of the embodiments contained herein, the true scope and breadth of the invention being defined by the claims as follows.

What is claimed is:

1. A seal for a pillow block carrying a rotating shaft comprising:
an annular body having an inner surface that opposes an outer surface;
a retaining channel defined by said inner surface; and
at least a first ring and a second ring disposed within said retaining channel, such that said first ring is engaged with the rotating shaft and carried therewith, and said second ring is engaged with said annular body of the seal.

2. The seal of claim 1, further comprising a third ring disposed within said retaining channel, which is engaged with the shaft.

3. The seal of claim 1, wherein said first ring comprises a double-wound laminar ring, and said second ring comprises a double-wound laminar ring.

4. The seal of claim 3, further comprising a third ring disposed within said retaining channel, said third ring comprising a double-wound laminar ring.

5. The seal of claim 2, wherein said first and third rings are separated by said second ring.

6. The seal of claim 1, further comprising at least one mounting channel defined by said outer surface of said annular body configured to engage the pillow block.

7. The seal of claim 6, further comprising an annular ring support extending from said outer surface of said annular body proximate to said mounting channel.

8. The seal of claim 7, wherein a seal ring is carried by said ring support.

9. A pillow block for a rotating shaft comprising:
a pillow block having at least one interface aperture to receive the rotating shaft therethrough; and
a seal disposed within said at least one aperture, said seal comprising:
an annular body having an inner surface that opposes an outer surface;
a retaining channel defined by said inner surface; and
at least a first ring and a second ring disposed within said retaining channel, such that said first ring is engaged with the rotating shaft and carried therewith, and said second ring is engaged with said annular body of said seal.

10. The pillow block of claim 9, further comprising a third ring disposed within said retaining channel, which is engaged with the shaft.

11. The pillow block of claim 9, wherein said first ring comprises a double-wound laminar ring, and said second ring comprises a double-wound laminar ring.

12. The pillow block of claim 11, further comprising a third ring disposed within said retaining channel, said third ring comprising a double-wound laminar ring.

13. The pillow block of claim 10, wherein said first and third rings are separated by said second ring.

14. The pillow block of claim 9, further comprising at least one mounting channel defined by said outer surface of said annular body configured to engage the pillow block.

15. The pillow block of claim 14, further comprising an annular ring support extending from said outer surface of said annular body proximate to said mounting channel.

16. The pillow block of claim 15, wherein a seal ring is carried by said ring support.

17. A seal for a pillow block that carries a rotating shaft comprising:
a rotating collar having an opposed inner and outer surface, and adapted to be attached and carried with the rotating shaft, said rotating collar having a retaining channel defined by said outer surface;
a fixed annular body having an opposed inner and outer surface, said annular body adapted to be mounted to the pillow block, said fixed annular body having an engagement flange that forms an engagement recess to receive at least a portion of said rotating collar, such that said engagement flange extends over said retaining channel; and
at least a first ring and a second ring disposed within said retaining channel, such that said first ring is engaged with said engagement flange and said second ring is engaged with said rotating collar, so as to be rotatably carried therewith.

18. The seal of claim 17, further comprising a third ring disposed within said retaining channel, which is engaged with said engagement flange.

19. The seal of claim 17, wherein said rotating collar is adapted to be attached to the shaft by a setscrew.

20. The seal of claim 17, wherein said rotating collar further comprises a ring channel defined by said inner surface of said rotating collar that carries a seal ring to sealingly engage the shaft.

21. A pillow block for a rotating shaft comprising:
a pillow block having at least one interface aperture to receive the rotating shaft therethrough;
a rotating collar having an opposed inner and outer surface, and adapted to be attached and carried with the rotating shaft, said rotating collar having a retaining channel defined by said outer surface;
a fixed annular body having an opposed inner and outer surface, said fixed annular body disposed in said at least one interface aperture of said pillow block, said fixed annular body having an engagement flange that forms an engagement recess to receive at least a portion of said rotating collar, such that said engagement flange extends over said retaining channel; and
at least a first ring and a second ring disposed within said retaining channel, such that said first ring is engaged with said engagement flange and said second ring is engaged with said rotating collar, so as to be rotatably carried therewith.

22. The pillow block of claim 21, further comprising a third ring disposed within said retaining channel, which are engaged with said engagement arm.

23. The pillow block of claim 21, wherein said rotating collar is adapted to be attached to the shaft by a setscrew.

24. The pillow block of claim 21, wherein said rotating collar includes a ring channel defined by said inner surface of said rotating collar that carries a seal ring to sealingly engage the shaft.
